(19) United States
(12) Patent Application Publication
(10) Pub. No.: US 2006/0149697 A1
(43) Pub. Date: Jul. 6, 2006

(54) Context data transmission

(76) Inventors: Andre Wachholz-Prill, Bellheim (DE); Markus Kupke, Dielheim (DE)

Correspondence Address: FISH & RICHARDSON, P.C., PO BOX 1022, MINNEAPOLIS, MN, 55440-1022, US

(21) Appl. No.: 11/027,763

(22) Filed: Jan. 3, 2005

(51) Int. Cl. G06F 17/30

(52) U.S. Cl. 707/1

(57) ABSTRACT

A method of providing a context-dependent tile for display on a client device includes: receiving at a server device a request from a client device for a tile, the tile being associated with a context identifier stored on the server device; requesting from the client device a context data portion that is associated with the context identifier, the context data portion being selected from context data stored on the client device; receiving at the server device the context data portion from the client device; and sending the tile from the server device to the client device, the tile being generated using the context data portion. The method may be implemented so that the request of the context data portion may be performed by sending a dummy tile to the client device. Additionally, the server device may retrieve the context identifier from a context repository.

### TECHNICAL FIELD

This invention relates to transmitting context data between a client and a server.

### BACKGROUND

In a client-server environment, client devices routinely request information from a server device for display in a graphical user interface (GUI). The information that the client device requests may depend on previous or past user actions and viewed web pages. This information may be called context data. For example, a user navigates to a web page that lists book titles, wherein each title provides more information about a particular book if the user clicks on the title. When the user clicks on a book title, the client device may request from the server device a page with more details on that book. Here, the book title information may be considered context data. When the user clicks on the book title, the client device uses the context data, which includes the book title, to request a web page from the server device. The server device then may return the web page that displays more details about that particular book.

Currently, some systems use a uniform resource locator (URL) of a hyperlink to pass context data when a user requests a new page in a browser. When a user clicks on the hyperlink, the context data is appended to the hyperlink's URL as a suffix. The URL is sent unencrypted to the server device, which uses the URL and the context data to create and return a web page for display on the client device. One disadvantage with this approach is that the transmission of context data is not secure. Another is that the context data may be visible to viewers from a browser's address bar after the requested page has been displayed by the client device. Also, the amount of data that the client device can pass using the URL may be limited.

Some systems use cookies to handle context data. A cookie is typically a text file stored on the client device by the client device (e.g., using Java Script) when a user views a particular web site stored on a server device. The text file contains context data such as information identifying the client device's user. The server device can employ the information identifying the user to associate the user with context data that is stored on the server device. For instance, an online store may place a cookie on a client device that identifies the client device's user. If the user then purchases an item through the web page, the server stores the user's credit card information on its database. The stored information is associated with the cookie identifying the user. The next time the user wants to buy an item, the user need not enter the credit card information because the server device uses the cookie stored on the client device to identify the user and retrieve the associated credit card information stored on the server device. Because the context data is stored on both the client device and the server device, centralized context data storage is not possible. Also, some users set their browsers to reject the use of cookies.

Other existing systems use client device applications with specific code specifying what context data to send when a page is requested from a server device. These client device applications make function calls to the server device for a requested page and use the specific code to send predetermined types of context data with the request. This approach may limit flexibility in changing the context data types and may add complexity to the client device application. Also in some existing systems, JavaScript variables are used to store the context data on the client device and HTML forms are used to post context data to the server device.

### SUMMARY

The present invention relates to transmitting context data between a client and a server. In a first general aspect, a method includes receiving at a server device a request from a client device for a tile. The tile is associated with a context identifier stored on the server device. A context data portion that is associated with the context identifier is requested from the client device. The context data portion is selected from context data stored on the client device. The server device receives the context data portion from the client device. The tile is sent from the server device to the client device. The tile is generated using the context data portion.

In selected embodiments, the request of the context data portion may be performed by sending a dummy tile to the client device. The dummy tile may contain a service provider identifier for a service provider to be used in generating the tile. The dummy tile may contain executable code causing the client device to select the context data portion from the context data and send the context data portion to the server device. The context data stored on the client device may be stored in variables that are recognized by executable code that extracts the context data portion.

In other selected embodiments, the server device may retrieve the context identifier from a context repository. Also, the server device may transmit the context data portion to a service provider for processing, and the service provider may transmit processed results to the server device for generating the tile. The processing in the service provider may comprise querying a database using the context data portion. The context data stored on the client device may include: information from a currently displayed tile, information from a previously displayed tile, information from a tile not visibly displayed to a user, and combinations thereof.

In other embodiments, the tile may be provided with executable code that when executed by the client device causes the client device to store new context data that is present in the tile. The server device may access a context identifier name repository on the server device to check for conflicts between a new context identifier in the new context data that is present in the tile and existing context identifier name entries previously entered in the context identifier name repository.

In still other embodiments, a user may remove from the client device a portable card storing the context data and subsequently connect the portable card to another client device. The other client device may use the context data stored on the portable card in requesting another tile. The new context data also may be stored on the portable card before removal from the client device. The new context data may be included in the tile that the client device received from the server device.

Advantages of the systems and techniques described herein may include any or all of the following: Improving security for a user's context data; improving the portability of context data; providing a more efficient centralized system for accessing context data; providing dynamic selection of a context data portion; avoiding conflicts between tiles related to the format and selection of new context data; sending any amount of data from a client device to a server device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary computer system that can transmit context data;

FIGS. 2A and 2B are examples of GUIs that can be generated by the system shown in FIG. 1;

FIG. 3 is a block diagram with further details of the computer system shown in FIG. 1;

FIG. 4 is a flow chart of an embodiment of an inventive method; and

FIG. 5 is a block diagram of a general computer system.

Like reference symbols in the various drawings indicate like elements.

### DETAILED DESCRIPTION

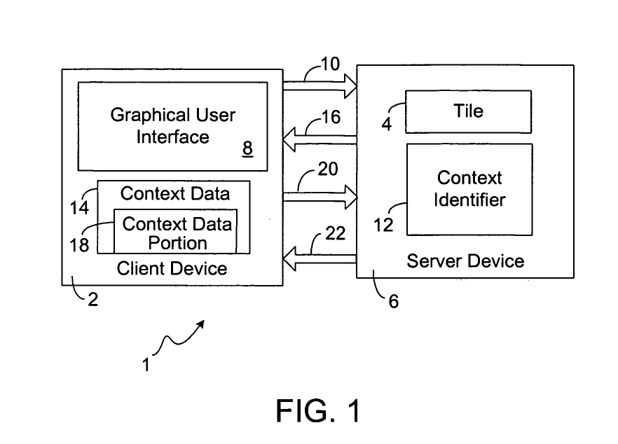

FIG. 1 shows a computer system 1, in which a client device 2 can request a tile 4 from a server device 6. The request for the tile 4 is represented by an arrow 10 going from the client device 2 and pointing towards the server device 6. The tile 4 may be a portion of a web page that is provided for the client device 2 to display on the client's GUI 8. A user may initiate the request 10 by clicking on a hyperlink. The server device 6 associates the client's request with a context identifier 12 that is stored on the server device 6. This association may be necessary because the server device 6 may require some or all of context data 14 from the client device 2 in generating the requested tile 4. The context identifier 12 specifies which portion 18 of the context data 14 the server device 6 may need.

The client's context data 14 is particular to the tiles that are currently or previously displayed in the GUI 8 and invisible tiles that are not visibly displayed to the user. When the client requests the tile 4, the server device 6 uses the context identifier 12 to send a request, represented by an arrow 16 to the client device. The server device's request calls for the client device to provide the portion 18 of the context data 14. That is, the context identifier 12 informs the server 6 as to which portion 18 of the context data 14 to request from the client 2. Accordingly, the server requests from the client 6 a context data portion 18 that is associated with the context identifier 12, wherein the context data portion 18 is selected from the context data 14 stored on the client device 2.

In response to the server device's request, the client device 2 sends the appropriate context data portion 18 to the server device 6 as represented by an arrow 20. The server device 6, in turn, uses the portion 18 to generate the tile 4. After the server device 6 has generated tile 4 using the portion 18, it sends the tile 4 to the client device 2 for display on the GUI 8. The transmission of the tile 4 sent by the server device 6 to the client device 2 is represented by the arrow 22 shown going from the server device 6 and pointing towards the client device 2. In other words, the server device 6 receives the context data portion 18 from the client device 2, and the tile 4 is sent from the server device 6 to the client device 2 after the tile 4 is generated using the context data portion 18. All of the above transmissions may take place in a separate connection or in a communication channel between the server device 6 and client device 2. The use of separate arrows in FIG. 1 does not imply that separate communication channels are necessary between the client device 2 and server device 6.

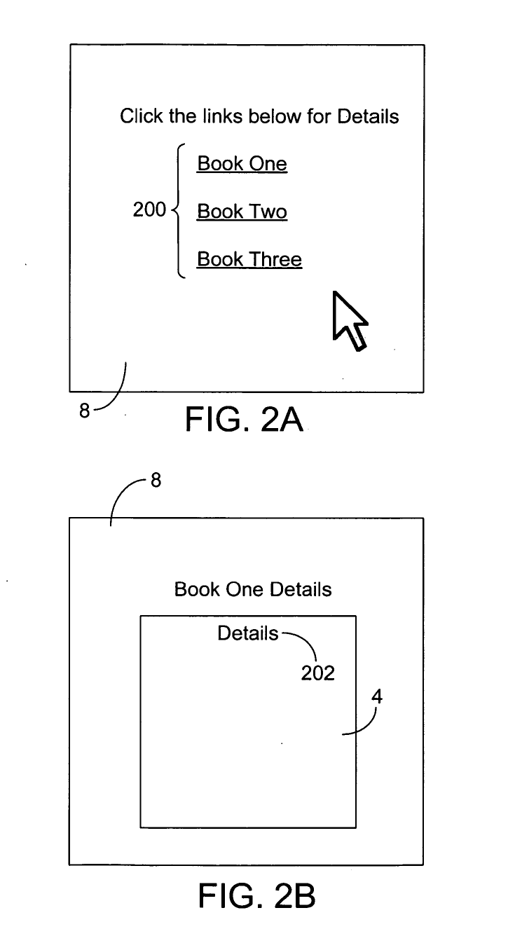

FIGS. 2A and 2B show the GUI 8 of FIG. 1 and illustrate what a user may see when using client device 2 of the computer system 1. In this example, a user is browsing an online bookstore and wants more details on a book. FIG. 2A shows a web page with a list 200 of book titles including “Book One,” “Book Two,” and “Book Three.” The text at the top of the page instructs the user to click on a hyperlink to find out more details about the book. The user clicks on the hyperlink with the title name “Book One.” Clicking on the hyperlink sends a request to the server device 6 for the tile 4 with more details on a book. Here, the request for more details does not specify on which book the user wants more details.

After receiving the request from the client device 2, the server device 6 uses the context identifier 12 associated with the requested tile 4 to determine what information the server device 6 may require to fulfill the request. In this example, tiles with book details are associated with a context identifier 12 that informs the server device 6 that the server device 6 requires the book title information of the hyperlink that the user selected. Thus, when the server device 6 receives a request for the tile 4 with book details, it accesses the associated context identifier 12. The identifier 12 informs the server device 6 that the book title information of the selected hyperlink is required for the server device 6 to generate the tile 4.

The server device 6 requests the book title information from the client device 2. The book title information is part of the context data 14 stored on the client device 2. The context data 14 also may contain other information, such as previously selected links or viewed web pages. The server device's request specifies, using the context identifier 12, which portion 18 of the context data 14 should send. In this example, the required information is the book title information of the hyperlink that the user selected. In response to the server device's request, the client device 2 may send the book title information for “Book One.” Note that the user may not see any of the client and server requests or transmissions displayed on the GUI 8.

Using the book title information, the server device 6 may generate a tile 4 with details about “Book One,” such as the author, the price, and the publisher. The server device 6 can send the tile 4 to the client device 2 for display on GUI 8. FIG. 2B shows the tile 4. The actual book details 202 are represented by the word “Details.” Also, the tile 4 may be a portion of a web page and it may not fill the entire display of the GUI 8. In another implementation, the hyperlinks for “Book Two” and “Book Three” could still be visible in a portion of GUI 8 so that the process of generating tiles with book details could be repeated if necessary.

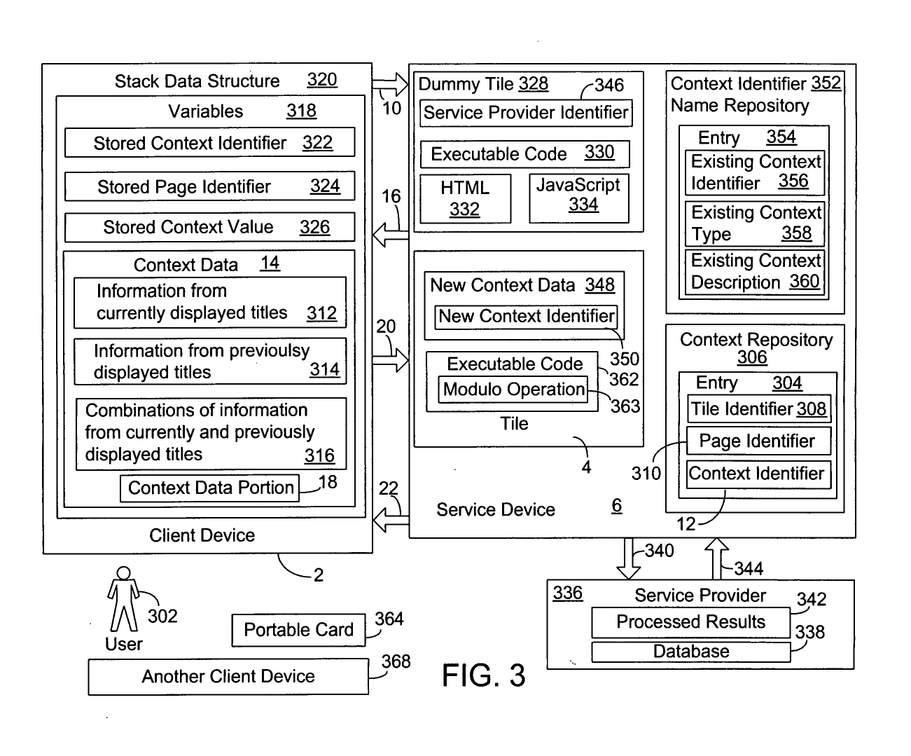

FIG. 3 shows additional details that can optionally be included in the system 1. Referring to FIG. 3, the client device 2 requests the tile 4 for display, as represented by the arrow 10. For example, a user 302 is currently viewing an intranet web page that instructs the user 302 to click on a month of the current year to obtain sales information for that month. Here, the sales information includes gross company sales, sales by company department, and sales by product. The user 302 clicks on a hyperlink titled “April,” which causes the client device 2 to request that the server device 6 return a tile 4 with sales information. The request does not include the month that the user 302 selected.

The server device 6 identifies what information it may require to produce the requested tile 4. Such information may be part of context data 14 that is stored on the client device 2. The server device 6 identifies the information using a context identifier 12, which is associated with the requested tile 4. The identifier 12 specifies a portion 18 of the context data 14 that the server device 6 may require to generate the requested tile 4. In this example, the relevant portion 18 of context data 14 is the month that was selected to initiate the request for a tile 4 with sales information.

The context identifier 12 may be part of an entry 304 in a context repository 306 implemented at the server device 6. The entry 304 also may include a tile identifier 308 and a page identifier 310. When the server device 6 receives a request for a tile 4, it accesses the context repository 306 to determine which context identifier 12 is associated with the tile 4. It does this by searching the entries in the context repository 306 for a tile identifier 308 that matches the requested tile 4. After a match is found, the server device 6 uses the rest of the entry, namely, the page identifier 310 and the context identifier 12, to inform the server device 6 which information it may require from the client device 2 to generate the requested tile 4. The server device 6 can use the page identifier 310 in the situation where the tile 4 is located on several different pages. For each page, the requested tile 4 may require a different portion of context data 14 from the client device 2. The server device 6 uses both the page identifier 310 and the context identifier 12 to determine which portion it may require to generate the requested tile 4 for a particular page.

The following is an example of the context data 14. As shown in FIG. 3, the context data 14 may include several types of data such as information from currently displayed tiles 312, information from previously displayed tiles 314, and combinations thereof. This information may be stored on the client device 2 as a stored context identifier 322 that provides a name to identify that particular stored context, a stored page identifier 324 that specifies a page that produced the context, and a stored context value 326 that holds the actual data values for the context. For instance, in the request for sales information example, the stored context identifier 322 could be the word “Month,” the stored page identifier 324 could be “SalesManangerScreen1,” and the stored context value 326 could be the word “April.” Note that the context data 14 may include other types of information besides those shown in FIG. 3, including previously selected links, previously and currently viewed web pages, the user's company position, and the language settings of the currently viewed page. The client device 2 may store the stored context identifier 322, the stored page identifier 324, and the stored context value 326 in variables 318, which are, in turn, stored in a stack data structure 320.

The server device 6 may use a dummy tile 328 to request the context data portion 18. The dummy tile may include executable code 330 that when executed causes the client device 2 to use the information obtained by the server device 6 from the context repository 306 to select the context data portion 18 from the context data 14. The code 330 also may cause the client device 2 to extract the portion 18 from the variables 318 and transmit this portion 18 back to the server device 6. The dummy tile may be an invisible HTML page 332 that is sent from the server device 6 to the client device 2. The executable code 330 may be implemented in JavaScript that is part of the HTML page 332, and it may post the portion 18 to the server device 6 using HyperText Transfer Protocol (HTTP), Secure HyperText Transfer Protocol (SHTTP), File Transfer Protocol (FTP), or other communication protocols. The dummy tile responds to the client device's request for a tile as if it were the requested tile 4. However, it does not contain the information of the requested tile 4, but instead gathers the required portion 18 for the server device 6.

When the portion 18 is sent to the server device 6, the server device 6 then may transmit it to a service provider 336 for processing. The server device 6 may generate the shell of the tile 4, but may use the service provider 336 to provide the content of the tile 4. The provider 336 may be a separate application, which contains a database 338, performs calculations, or combines both. The server device 6 can transmit the portion 18 to the provider 336, wherein the transmission is represented by the arrow 340. The provider 336 can query the database 338 using the data in the portion 18 as a parameter and obtain process results 342. The provider 336 can transmit the processed results 342 to the server device 6, wherein this transmission is represented by an arrow 344. The server device 6 then can use the processed results 342 to provide the content for the tile 4. For example, a server device 6 may transmit to a service provider 336 a portion 18 that contains information specifying a request for April sales information. The provider 336 can query the database 338 using the month of April as a parameter, produce the sales information for that month, and transmit the sales information for April to the server device 6. The server device 6 then may use the April sales information to instantiate a tile 4.

The server device 6 may include a service provider identifier 346 in the dummy tile in response to the client device's request for the tile 4. The requested tile 4 may require the server device 6 to use one or more service providers to generate the tile 4. The server device 6 may determine which service providers are required and include corresponding service provider identifiers in the dummy tile before the dummy tile is sent to the client device 2. Accordingly, the server device 6 avoids determining the appropriate service providers a second time when the dummy tile transmits the context data portion 18 and the service provider identifiers to the server device 6.

The tile 4 generated by the server device 6 using the processed results 342 may contain new context data 348, including a new context identifier 350, to be stored on the client device 2. Before the new context identifier 350 is sent with the tile 4 to the client device 2, a context identifier name repository 352 may be accessed to determine whether there are conflicts between the new context identifier 350 and existing entries. An entry 354 contains an existing context identifier 356 that provides a name to identify that particular existing context, an existing context type 358 that specifies the variable type, such as an integer or string, and an existing context description 360 that provides a statement describing the particular context. The server device 6 compares the new context identifier 350 to an entry 354 with the same context identifier, and if the identifier 350 corresponds to the entry 354, the server device 6 may transmit the tile 4 with the new context data to the client device 2. If the new context identifier 350 does not match, an alternative context identifier may be used for the information identified by the identifier 350. The same process may be repeated until there are no conflicts between the new context identifier 350 and the entries in the repository 352. If there is no matching entry for a new context identifier 350, the server device 6 will insert a new entry that corresponds to the identifier 350.

Next, the server device 6 sends the generated tile 4 to the client device 2 for display on the GUI 8, as represented by an arrow 22. The tile 4 may contain executable code 362 that requests the client device 2 to store the new context data 348 that is present in the tile 4. The client device 2 may respond by pushing the data 348 into the stack data structure 320. The executable code 362 also may request that the client device 2 limit the amount variables 318 placed in the stack data structure 320. This may be implemented using a modulo operation 363, which specifies what number of contexts the structure 320 can store. Additionally, the executable code 362 may request that the client device 2 not store the same contexts multiple times. This may be implemented by requesting the client device 2 to determine whether the currently displayed tile is the same as the requested tile 4. If the tiles are the same, the client device 2 may be instructed to not store the new context data 348 in the structure 320.

The user 302 may store the context data 14 in a portable card 364 for use in another client device 368. Because the context data 14 may be stored centrally on the client device 2, the client device 2 can transfer or transmit all of the data 14 to the portable card 364. Consequently, the user 302 can insert the card 364 into the other client device 368 and easily view the same tiles, have the same context history, and easily transport any user identification. Additionally, the card 14 may prevent subsequent users from accessing any context data 14 of user 302 if the user 302 transfers all the data 14 to the card 364. The user 302 may remove or insert the card from the client device 2 at any point including before or after the new context data 348 is stored on the client device 2.

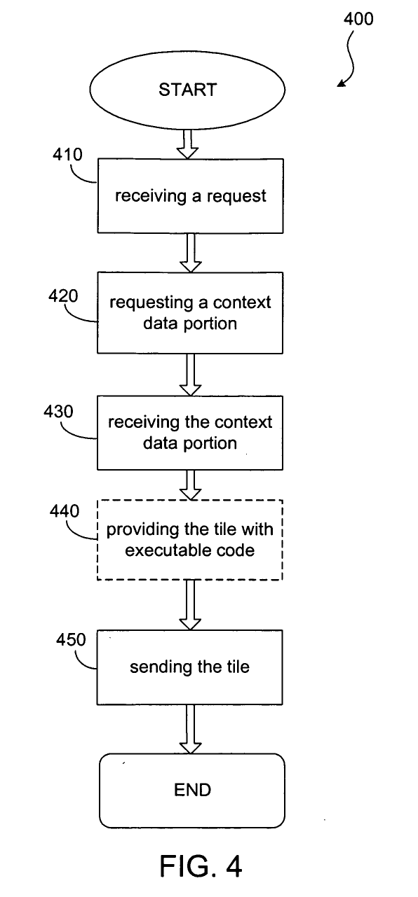

FIG. 4 is a flow chart of method 400 that can be performed in the computer system 1. For example, a computer program product may include instructions that cause a processor to perform operations comprising the steps of the method 400. As shown in FIG. 4, the method 400 includes the following steps:

Receiving a request in step 410. The request is sent from a client device and requests a tile from a server device. The tile is associated with a context identifier stored on the server device. For example, the user clicks on a hyperlink, which initiates a request that is sent from the client device 2 to the server device 6. The request may be for the tile 4. The tile 4 is associated with the context identifier 12 that may indicate additional information that the server device 6 requires to provide the requested tile 4. Upon receiving the request, the server device 6 may retrieve the context identifier 12 from the context repository 306 implemented at the server device 2.

Requesting a context data portion in step 420. The request is sent from the server device and requests a context data portion from the client device. The requested context data portion is associated with the context identifier, and the portion is selected from context data stored on the client device. For example, the server device 6 may use the dummy tile 328 to perform the request 16 from the client device 2 for the context data portion 18. The dummy tile 328 can contain the executable code 330 that causes the client device 2 to select the context data portion 18 from the context data 14. The context data 14 may be stored in the variables 318 that are recognized by the executable code 330 used to extract the portion 18.

Receiving the context data portion in step 430. The server device receives the context data portion from the client device. For example, the executable code 330 contained in the dummy tile 328 causes the client device 2 to send the portion 18 to the server device 6, which receives the portion 18. The dummy tile 328 may be implemented as an invisible HTML page with the executable code 330 implemented in JavaScript that selects the portion 18 and posts the portion 18 to the server device 6.

Providing, in optional step 440, the tile with executable code. The server device provides the requested tile with executable code that causes the client device to store new context data that is present in the tile. For example, during generation of the requested tile 4, the server device 6 provides the tile 4 with the executable code 362. The code 362 causes the client device 2 to store the new context data 348 that is present in the tile 4.

Sending the tile in step 450. The server device sends the tile to the client device. The tile is generated using the context data portion. For example, in generating the tile 4, the server device 6 may transmit the portion 18 to the service provider 336, which processes the portion 18 and returns the processed results 342 to the server device 6. The server device 6 may use the processed results in generating the tile 4, wherein generating the tile also may include generating new context data 348 in the tile 4. The server device 6 sends the generated tile 4 to the client device 2.

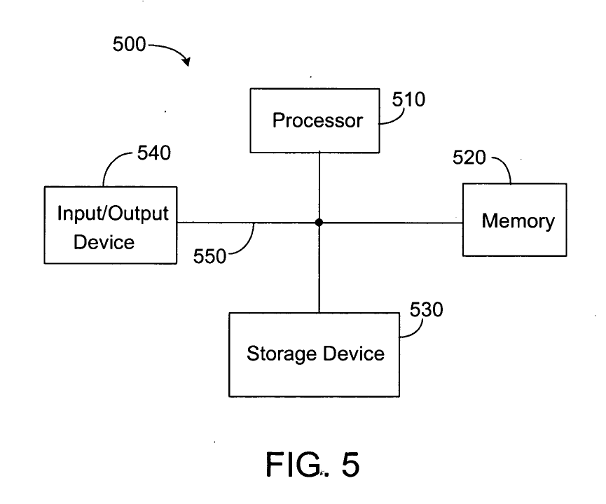

FIG. 5 is a block diagram of a computer system 500 that can be used in the operations described above, according to one embodiment. For example, the system 500 may be included in any or all of the client device 2, the server device 6, the service provider 336, and the other client device 368.

The system 500 includes a processor 510, a memory 520, a storage device 530 and an input/output device 540. Each of the components 510, 520, 530 and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for the GUI 8 on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying the GUI 8.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, the user may remove or insert the portable card in the client device at any time, including before or after the new context data that is present in the generated tile is stored on the client device. Additionally, process steps may be optional, such as providing the tile with executable code that causes the client device to store new context data that is present in the tile. Accordingly, other embodiments are within the scope of the following claims.

What is claimed is:

1. A method of providing a context-dependent tile for display on a client device, the method comprising:
receiving at a server device a request from a client device for a tile, the tile being associated with a context identifier stored on the server device;
requesting from the client device a context data portion that is associated with the context identifier, the context data portion being selected from context data stored on the client device;
receiving at the server device the context data portion from the client device; and
sending the tile from the server device to the client device, the tile being generated using the context data portion.

2. The method of claim 1, wherein the request of the context data portion is performed by sending a dummy tile to the client device.

3. The method of claim 2, wherein the dummy tile contains a service provider identifier for a service provider to be used in generating the tile.

4. The method of claim 2, wherein the dummy tile contains executable code causing the client device to select the context data portion from the context data and send the context data portion to the server device.

5. The method of claim 2, wherein the dummy tile is an invisible HTML page with JavaScript causing the client device to select the context data portion from the context data and post the context data portion to the server device.

6. The method of claim 2, wherein the dummy tile responds as if it were the tile requested by the client device.

7. The method of claim 1, wherein the server device retrieves the context identifier from a context repository.

8. The method of claim 7, wherein the context repository includes several entries, each of the entries including a tile identifier, a page identifier, and the context identifier.

9. The method of claim 8, wherein the context identifier is selected for retrieval using the tile identifier and the page identifier.

10. The method of claim 1, wherein the context data stored on the client device is stored in variables that are recognized by executable code that extracts the context data portion.

11. The method of claim 10, wherein the variables contain a stored page identifier, a stored context value, and a stored context identifier that may be used to generate the tile.

12. The method of claim 11, wherein the variables are stored in a stack data structure.

13. The method of claim 12, wherein the tile contains the executable code, and wherein the executable code also limits an amount of variables that can be stored in the stack data structure.

14. The method of claim 13, wherein the executable code uses a modulo operation in limiting the amount of variables.

15. The method of claim 1, wherein the server device transmits the context data portion to a service provider for processing, and wherein the service provider transmits processed results to the server device for generating the tile.

16. The method of claim 15, wherein the processing in the service provider comprises querying a database using the context data portion.

17. The method of claim 1, wherein the context data stored on the client device includes information selected from a group consisting of: information from a currently displayed tile, information from a previously displayed tile, information from a tile not visibly displayed to a user, and combinations thereof.

18. The method of claim 17, wherein the information from the currently displayed tile, the information from the previously displayed tile, and the combinations thereof includes a stored page identifier, a stored context value, and a stored context identifier.

19. The method of claim 1, further comprising providing the tile with executable code that when executed by the client device causes the client device to store new context data that is present in the tile.

20. The method of claim 19, wherein the server device accesses a context identifier name repository on the server device to check for conflicts between a new context identifier in the new context data that is present in the tile and existing context identifier name entries previously entered in the context identifier name repository.

21. The method of claim 20, wherein each of the existing context identifier name entries includes an existing context identifier, an existing context type, and an existing context description.

22. A computer program product containing executable instructions that when executed cause a processor to perform operations comprising:
receive at a server device a request from a client device for a tile, the tile being associated with a context identifier stored on the server device;
request from the client device a context data portion that is associated with the context identifier, the context data portion being selected from context data stored on the client device;
receive at the server device the context data portion from the client device; and
send the tile from the server device to the client device, the tile being generated using the context data portion.

23. The method of claim 1, wherein a user removes from the client device a portable card storing the context data and subsequently connects the portable card to another client device, and wherein the other client device uses the context data stored on the portable card in requesting another tile.

24. The method of claim 23, wherein new context data also is stored on the portable card before removal from the client device, the new context data having been included in the tile that the client device received from the server device.
